(19) United States
(12) Patent Application Publication
(10) Pub. No.: US 2014/0313027 A1
(43) Pub. Date: Oct. 23, 2014

(54) HEADLIGHT STATUS DISPLAY SYSTEM FOR AUTOMOBILE

(71) Applicant: Fenton C. Johnson, Indianapolis, IN (US)

(72) Inventor: Fenton C. Johnson, Indianapolis, IN (US)

(21) Appl. No.: 13/866,225

(22) Filed: Apr. 19, 2013

(51) Int. Cl. B60Q 11/00

(52) U.S. Cl. CPC B60Q 11/005
USPC 340/458

(57) ABSTRACT

A headlight status display system for automobile that includes a plurality of spare bulbs wired in a secondary relay circuit, each of said plurality of spare bulbs disposed proximal each of a plurality of primary bulbs wired in a first relay circuit, wherein failure of any one of said plurality of primary bulbs is detectable and communicable to a driver and, simultaneously, a corresponding one of the plurality of spare bulbs is illuminable in lieu of said failed primary bulb, whereby an automobile's visibilty is ensured and proper functioning of either headlight or rear light is maintained.

### BACKGROUND OF THE INVENTION

Various types of reserve headlight systems for automobiles are known in the prior art. However, what is needed is a headlight status display system for automobile that includes a plurality of spare bulbs wired in a secondary relay circuit, each of said plurality of spare bulbs disposed proximal each of a plurality of primary bulbs wired in a first relay circuit, wherein failure of any one of said plurality of primary bulbs is detectable and communicable to a driver and, simultaneously, a corresponding one of the plurality of spare bulbs is illuminable in lieu of said failed primary bulb, whereby an automobile's visibilty is ensured and proper functioning of either headlight or rear light is maintained.

### FIELD OF THE INVENTION

The present invention relates to a headlight status display system for automobile, and more particularly, to a headlight status display system for automobile that includes a plurality of spare bulbs wired in a secondary relay circuit, each of said plurality of spare bulbs disposed proximal each of a plurality of primary bulbs wired in a first relay circuit, wherein failure of any one of said plurality of primary bulbs is detectable and communicable to a driver and, simultaneously, a corresponding one of the plurality of spare bulbs is illuminable in lieu of said failed primary bulb, whereby an automobile's visibilty is ensured and proper functioning of either headlight or rear light is maintained.

### SUMMARY OF THE INVENTION

The general purpose of the headlight status display system for automobile, ii described subsequently in greater detail, is to provide a headlight status display system for automobile which has many novel features that result in a headlight status display system for automobile which is not anticipated, rendered obvious, suggested, or even implied by prior art, either alone or in combination thereof.

The present invention has been devised to maintain visibility while operating an automobile at night or in other low light conditions, even when a primary bulb in either a headlight or rear light fails. A respective spare bulb, situated within a corresponding headlight or rear light, is immediately illuminated when a central processing unit senses the failure of said primary bulb and, simultaneously, an indicator light is illuminated upon a console disposed interiorly within the automobile to signal to the driver the failure of the primary bulb. The driver is thus enabled to continue to operate the automobile in low light conditions, without reduced visibility, and may therefore take corrective action, as desired, at the next most convenient opportunity.

A plurality of spare bulbs is contemplated, each of said plurality of spare bulbs disposed adjacent or proximal to a respective primary bulb. When a particular primary bulb fails, therefore, the central processor switches to the respective spare bulb in order that usual illumination of the particular headlight or rear light be maintained, and adequate visibility ensured. Thus, whether a primary bulb fails in a headlight, for example, and disables the high beam functioning thereof, or the low beam functioning thereof, a corresponding spare bulb is instantaneously illuminable thereat and the normal functioning of said headlight remains.

The present headlight status display system for automobile, therefore, includes a first relay circuit interconnecting a plurality of primary bulbs within each of said automobile's headlights and rear lights. A secondary relay circuit effectively interconnects each of the plurality of spare bulbs, each of said spare bulbs disposed proximal to each of a corresponding primary bulb. A central processing unit (“CPU”) is disposed in operational communication with each of the first relay circuit and the secondary relay circuit. A first sensor is disposed in communication with the first relay circuit to register failure or any one of the primary bulbs, and communicate said failure to the CPU. A second sensor is likewise disposed in communication with the secondary relay circuit to register failure of any one of the spare bulbs and communicate said failure to the CPU.

A plurality of indicator lights is disposed upon a trapezoidal console configured for situation upon, or proximal to, an extant dashboard of a vehicle to which the device is installed. The console includes indicator lights corresponding to each of the vehicle's headlights and rear lights. Thus, when a primary bulb is sensed to fail, and a spare bulb is illuminated, said action is exemplified upon the console. A driver is thus alerted to the situation, and corrective action is prompted at the next convenient opportunity.

Should one of the plurality of spare bulbs fail during use, such failure is sensed across the secondary relay circuit by means of the second sensor, and the CPU actuates an alert signal displayed upon the console. A driver of the vehicle is thus alerted to the emergent need to take corrective action and replace said bulb to maintain proper visibility when operating the automobile in low light conditions.

It should be readily ascertained from the foregoing that the present invention not only ensures increased safety in operating a particular automobile to which the device is installed, but also the visibility of the particular automobile is ensured to other road users whereby accidents are more likely avoided.

Thus has been broadly outlined the more important features of the present headlight status display system for automobile so that the detailed description thereof that follows may be better understood and in order that the present contribution to the art may be better appreciated.

Objects of the present headlight status display system for automobile, along with various novel features that characterize the invention are particularly pointed out in the claims forming a part of this disclosure. For better understanding of the headlight status display system for automobile, its operating advantages and specific objects attained by its uses, refer to the accompanying drawings and description.

### BRIEF DESCRIPTION OF THE DRAWINGS

### Figures

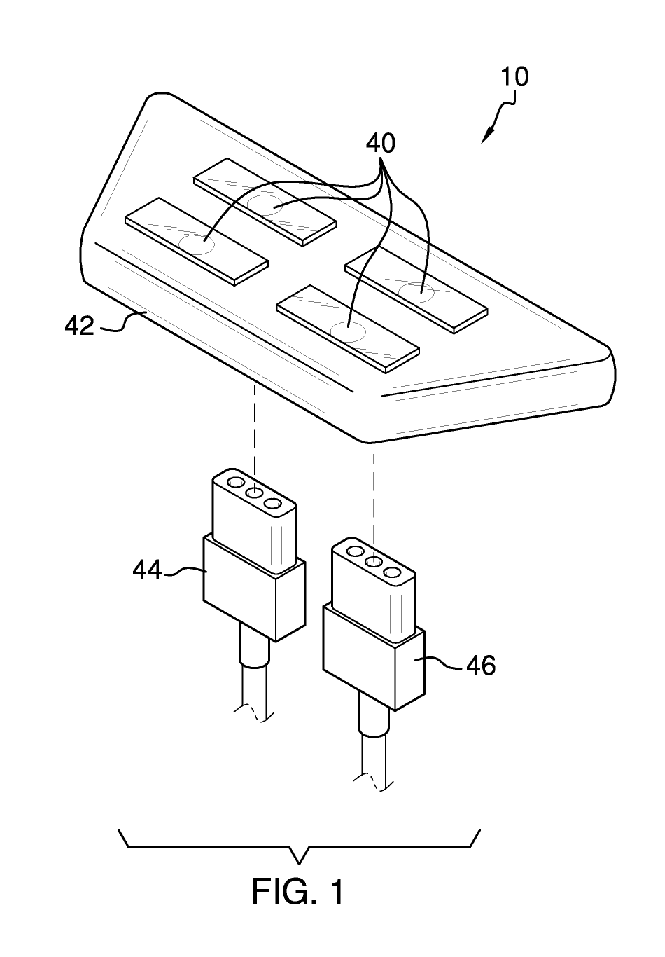

FIG. 1 is an isometric view.

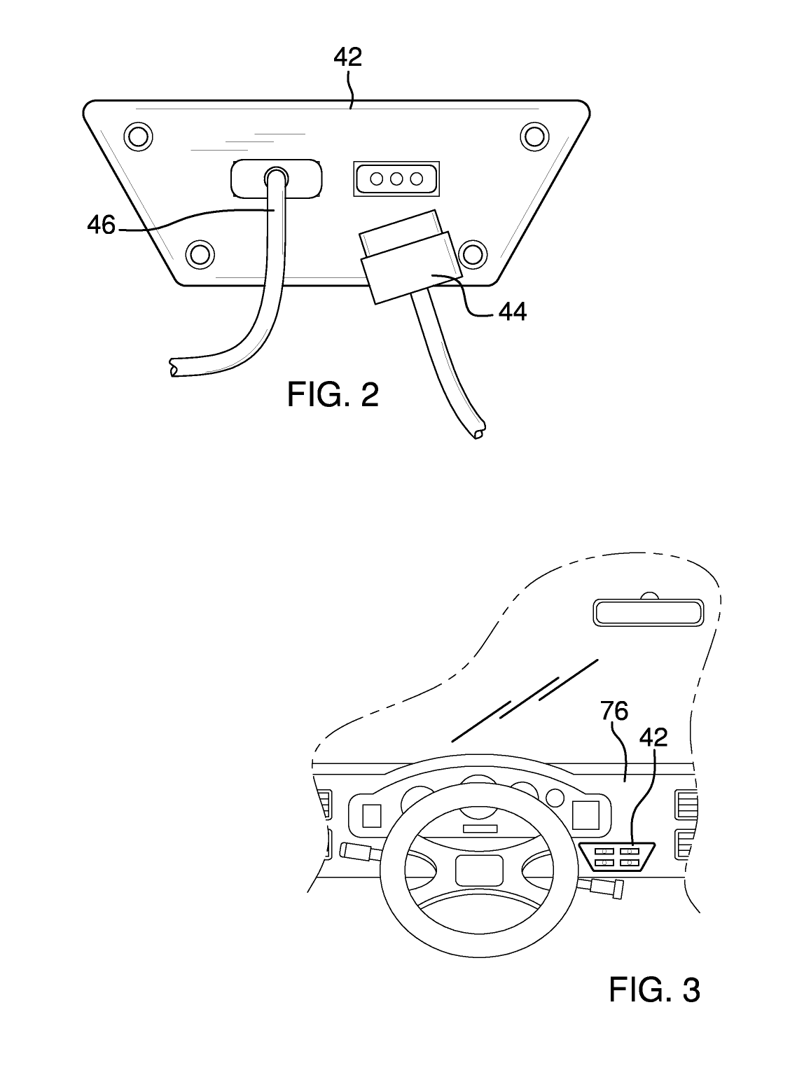

FIG. 2 is a rear view of console.

FIG. 3 is an in-use view with the device installed upon an automobile.

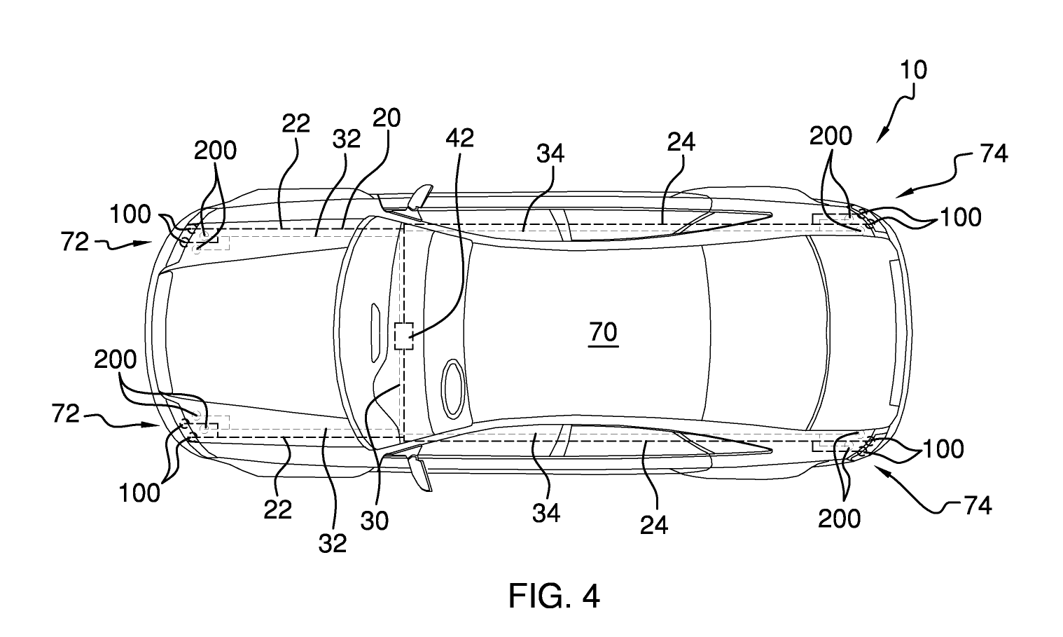

FIG. 4 is an in-use view of the device installed upon an automobile.

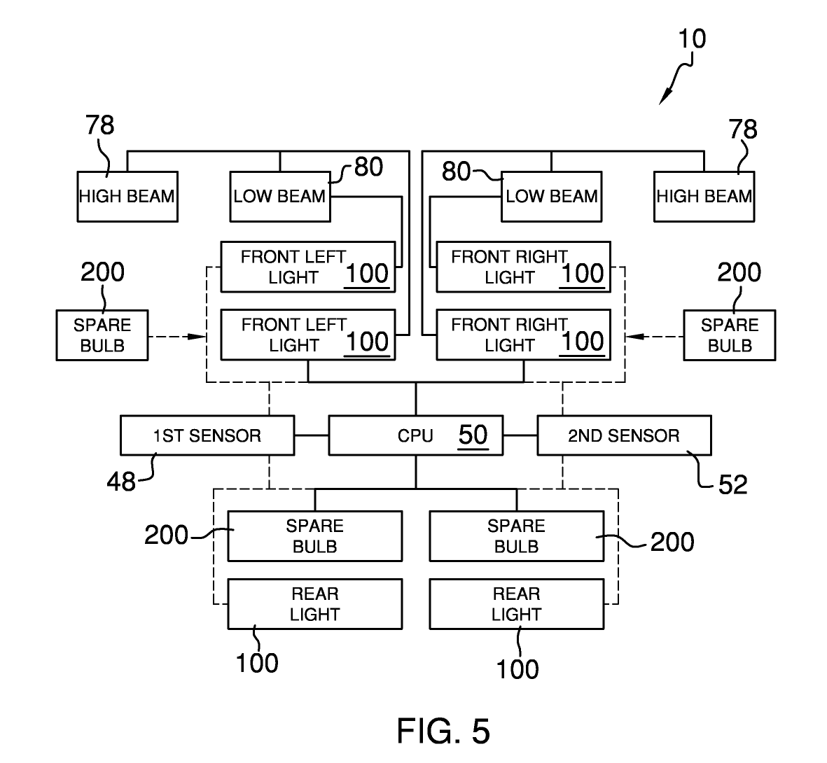

FIG. 5 is a block diagram.

### DETAILED DESCRIPTION OF THE DRAWINGS

With reference now to the drawings, and in particular FIGS. 1 through 5 thereof, example of the instant headlight status display system for automobile employing the principles and concepts of the present headlight status display system for automobile and generally designated by the reference number 10 will be described.

Referring to FIGS. 1 through 5 a preferred embodiment of the present headlight status display system for automobile 10 is illustrated.

The present invention 10 has been devised to increase safety when operating an automobile 70 at night or in other low light conditions. The present headlight status display system for automobile 10 alerts a driver when a primary bulb 100 fails, activates a spare bulb 200 to maintain illumination of the particular light which lost said primary bulb 100, and illuminates an indicator light 40 disposed upon a console 42 within the automobile 70 interior to signal said primary bulb 100 failure to the driver whereby corrective action is prompted. However, the spare bulb 200 ensures maintained visibility for the driver in the absence of the primary bulb 100.

The present headlight status display system for automobile 10, then, includes a first relay circuit 20 interconnecting a plurality of primary bulbs 100, each of said plurality of primary bulbs 100 disposed to illuminate each of an extant pair of headlights 72 along a first path 22 and each of an extant pair of rear lights 74 along a second path 24. A plurality of spare bulbs 200 are wired along a secondary relay circuit 30, and each of said plurality of spare bulbs 200 are disposed to illuminate a respective one of the extant pair of headlights 72 and a respective one of the extant pair of rear lights 74 when a respective one of the plurality of primary bulbs 100 dies. Thus, as shown in FIG. 4 the plurality of spare bulbs 200 are likewise wired along a first path 32 and a second path 34 within the secondary relay circuit 30.

To house and display each of a plurality of indicator lights 40, each signaling failure of a respective primary bulb 100 and illumination of a respective spare bulb 200, a trapezoidal console 42 is disposed to outface from an extant dashboard 76 (or other surface proximal thereto interior to an extant automobile 70). The plurality of indicator lights 40 is disposed upon the console 42, each of said plurality of indicator lights 40 connectable in circuit with each of the first and secondary relay circuits 20, 30. When any one of the plurality of primary bulbs 100 fails, therefore, a respective one of the plurality of spare bulbs 200 is illuminated to maintain driver visibility. Simultaneously, an indicator light 40, corresponding to the particular primary bulb 100 which was sensed to have failed, is illuminated upon the console 42.

As shown in FIG. 1, a first jack 44 is connectable into a rear side of the console 42, said first jack 44 wired in circuit with the first path 22, 32 of each of the first relay circuit 20 and the secondary relay circuit 30. A second jack 46 is likewise connectable into the rear side of the console 42, said second jack 46 also wired in circuit with second path 24, 34 of each of the first relay circuit 20 and the secondary relay circuit 30.

A first sensor 48 is disposed in circuit with the first relay circuit 20. When a filament in a primary bulb 100 fails, and a path in the first relay circuit 20 is broken, the first sensor 48 registers the drop in voltage therein, and a central processing unit 50 (“CPU”) activates the corresponding path within the secondary relay circuit 30 whereby the respective spare bulb 200 is simultaneously illuminated (to maintain driver visibility) and the respective indicator light 40 is illuminated (to signal the failure of the primary bulb 100 to the driver).

A second sensor 52 is disposed in circuit with the secondary relay circuit 30. ii Should a failure across the secondary relay circuit 30 be sensed, the second sensor 52 alerts the CPU 50 and a warning signal is communicated to the console 42. The warning signal may be the illumination of an indicator light 40 corresponding to the particular spare bulb 200 which is sensed to have failed, or, alternately, may include a flashing of the indicator light 40 corresponding to the previously failed primary bulb 100. In either case, failure of a spare bulb 200 is communicated to the driver so that immediate corrective action is prompted.

The CPU 50 is thus disposed within the console 42 and maintains operational control between each of the first and second sensors 48, 52 and both the first relay circuit 20 and the secondary relay circuit 30. It should be noted that, while the preferred embodiment discloses only a single primary bulb 100 for each respective spare bulb 200 disposed in each of the particular headlights 72 and rear lights 74 wherein the present device is operative, the invention 10 contemplates spare bulbs 200 for both high beam 78 and low beam 80 applications of the headlights 72, and, therefore, additional spare bulbs 200 disposed upon the secondary relay circuit 30 are considered that enable and maintain high and low beam functioning of the particular headlight 72 in the absence of either primary bulb 100 (see FIG. 5). Moreover, alternate types of bulbs are considered, including, but not limited to, Light Emitting Diode bulbs, whereby a smaller bulb may comprise the spare bulb 200 than that of the primary bulb 100, as desired, when fitting the invention 10 to a particular make or model of automobile.

Thus the present invention 10 effectively enables an entire set of duplicate headlights 72 and rear lights 74 able to activate and maintain visibility whenever any one of said primary bulbs 100 fails. The CPU 50 effectively substitutes respective spare ii bulbs 200 in circuit with the remaining primary bulbs 100, while simultaneously signaling the failure of said primary bulb 100 to the attention of the driver. Failure of a spare bulb 200 is also urgently signaled to the driver in order that immediate corrective action be taken.

What is claimed is:

1. A headlight status display system for automobile comprising:
a first relay circuit interconnecting a plurality of primary bulbs, each of said plurality of primary bulbs disposed to illuminate each of an extant pair of headlights along a first path and each of an extant pair of rear lights along a second path;
a secondary relay circuit interconnecting a plurality of spare bulbs, each of said plurality of spare bulbs disposed to illuminate a respective one of the extant pair of headlights and a respective one of the extant pair of rear lights when a respective one of the plurality of primary bulb fails;
a trapezoidal console disposed to outface from an extant dashboard;
a plurality of indicator lights disposed upon the console, each of said plurality of indicator lights connectable in circuit with each of the first and secondary relay circuits;
a first jack connectable into a rear side of the console, said first jack wired in circuit with the first path of each of the first relay circuit and the secondary relay circuit;
a second jack connectable into the rear side of the console, said second jack wired in circuit with second path of each of the first relay circuit and the secondary circuit;
a first sensor disposed in circuit with the first relay circuit;
a second sensor disposed in circuit with the secondary relay circuit;
a central processing unit disposed within the console in operational control with each of the first and second sensors and both the first relay circuit and the secondary relay circuit;
wherein a respective indicator light illuminates upon the console to signify the failure of one of the plurality of primary bulbs and a respective spare bulb illuminates in lieu of said failed primary bulb whereby a driver is alerted of the need to replace the failed primary bulb while illumination of both the pair of headlights and pair of rear lights of the automobile is maintained.

2. The headlight status display system for automobile of claim 1 wherein the secondary relay circuit further comprises additional spare bulbs in each of the automobile headlights whereby high beam and low beam use of said headlights is maintained when any one of the plurality of primary bulbs fails.

3. The headlight status display system for automobile of claim 2 wherein the central processing unit activates a respective spare bulb when the failure of a corresponding primary bulb is sensed by means of the first sensor wherein said respective spare bulb is illuminated in lieu of the failed primary bulb whereby normal functioning of the automobile headlights and rear lights is maintained when any one of the plurality of primary bulbs fails.

4. The headlight status display system for automobile of claim 3 wherein the central processing unit activates a warning signal displayed upon the console when a failure of any one of the plurality of spare bulbs is sensed by means of the second sensor.
